(19) United States
(12) Patent Application Publication
(10) Pub. No.: US 2011/0017098 A1
(43) Pub. Date: Jan. 27, 2011

(54) REMOVAL AND RECOVERY OF DYE WASTE FROM EFFLUENTS USING CLAY

(75) Inventors: Dennis Wambuguh, Columbia, MO (US); Russell R. Chianelli, El Paso, TX (US)

Correspondence Address: CHALKER FLORES, LLP, 2711 LBJ FRWY, Suite 1036, DALLAS, TX, 75234, US

(73) Assignee: BOARD OF REGENTS, THE UNIVERSITY OF TEXAS SYSTEM, Austin, TX (US)

(21) Appl. No.: 12/830,198

(22) Filed: Jul. 2, 2010

Related U.S. Application Data
(60) Provisional application No. 61/222,998, filed on Jul. 3, 2009.

(51) Int. Cl. C04B 14/04; C02F 1/42

(52) U.S. Cl. 106/484; 210/638

(57) ABSTRACT

The present invention describes the use of clay (palygorskite) to concurrently remove indigo dye and salts from the wastewater and subsequent conversion of recovery by-products into Maya blue, an organic-inorganic hybrid pigment with applications in the paint and coating industry. The present invention provides an attractive alternative to discharging the untreated effluent into municipal treatment plants or the environment through the production of a secondary commercial product from waste stream through a by-product synergy process.

### CROSS-REFERENCE TO RELATED APPLICATIONS

This application claims priority to U.S. Provisional Application Ser. No. 61/222,998 filed Jul. 3, 2009, the entire contents of which is incorporated herein by reference.

### TECHNICAL FIELD OF THE INVENTION

The present invention relates in general to the field of effluent treatment and recovery and more particularly to the recovery of an indigo dye waste from an effluent by adsorption onto clay and the subsequent conversion of the recovered dye to a commercially useful product.

### STATEMENT OF FEDERALLY FUNDED RESEARCH

### None

### INCORPORATION-BY-REFERENCE OF MATERIALS FILED ON COMPACT DISC

None.

### BACKGROUND OF THE INVENTION

Without limiting the scope of the invention, its background is described in connection with the development of a method for recovering indigo dye waste from an effluent stream by adsorption onto clay and the subsequent conversion of the recovered by-product to a commercially valuable Maya-Blue type pigment.

U.S. Pat. No. 4,045,171 issued to Lancy (1977) discloses process for the removal of colorants from industrial dye waste solutions which involves the treatment of the waste with a solution of a Group IA or IIA metal halide or sulfate to precipitate the colorant, which subsequently is removed by common solid separation techniques as a dense material of relatively high solids content.

U.S. Pat. No. 5,980,981 issued to Patterson et al. (1999) describes a process for desizing and cleaning fabrics and garments which produces a substantially desized fabric or garment while holding the dye that is removed from the garment in suspension in the bath. The process includes the steps of immersing the woven fabric or garments in an aqueous bath containing a desizing agent and maintaining the fabric in the desizing bath for a time sufficient to desize the goods while minimizing the removal of dye present in the goods. The desizing agent includes a clay and at least one surfactant.

Publication No. CN101314487 (Ma et al., 2008) discloses a method for removing cationic dye in dyeing waste water by using milled lava. The lava powder is added to the waste water which contains cationic dye with stirring. The cationic dye is fixedly absorbed on the surface of the lava and is precipitated and separated.

### SUMMARY OF THE INVENTION

The present invention describes an attractive and cost-effective way of removing indigo dye and salts from wastewater by adsorption onto a clay (palygorskite) and subsequent conversion of recovery by-products into Maya blue, an organic-inorganic hybrid pigment with applications in the paint and coating industry.

In one embodiment the present invention teaches a method for removing a suspected dye contaminant from a waste stream comprising either solid or liquid wastes by adsorption onto a crystalloid hydrous silicate mineral. In the first step the mixing waste stream comprising the suspected contaminant dye is mixed with water in a tank to form a suspension, followed by filtration through a mesh to remove suspended solids. In the next step, the crystalloid hydrous silicate mineral is added to the filtered suspension with mixing in a mixing tank and the mixing is carried out for at least 24 hours. The mixing step is followed by a settling step wherein the mixture of the crystalloid hydrous silicate mineral and the filtered suspension is allowed to settle for at least two hours to form a clear supernatant solution and a solid residue. Finally, the clear supernatant solution is separated from the solid residue comprising the dye contaminant adsorbed on the from the hydrous silicate mineral. The method of the present invention further comprises the steps of: (i) recycling the clear supernatant solution, (ii) drying the solid residue comprising the adsorbed dye contaminant at a temperature not below 100° C. and for at least 24 hours, (iii) grinding the dried solid residue comprising the adsorbed dye contaminant and (iv) adding pure fractions of the suspected dye contaminants in varying amounts to the dried and ground solid residue to form a new pigment for further use.

In one aspect the hydrous silicate mineral used in the method of the present invention is selected from one or more clays, soil, Palygorskite, mineral silicates, bentonite, or any combinations thereof. In another aspect of the present invention the suspected dye contaminant comprises indigo blue, acid dyes, basic dyes, mordant dyes, vat dyes, azo dyes, or any combinations thereof. In addition to the suspected dye contaminants the method of the present invention further removes 30, 40, 50 or 60% of the salt and dye in the waste stream.

In a certain aspect the pigment formed by the method of the present invention comprises Maya blue, metallic pigments, carbon pigments, organic pigments, biological pigments, or any combinations thereof formed by adding pure fractions of the suspected dye contaminant is added at a weight percentages of 1%, 2%, 4%, 6%, and 8%. In yet another aspect of the present invention the hydrous silicate mineral is selected from [Si₈Mg₅O₂₀(OH)₂] (H₂O)₄.4H₂O, derivatives or salts thereof. In further aspects of the present invention the clear supernatant solution is recycled for use in a stonewash process, as irrigation water, as industrial grade water and for other processes and applications not requiring potable water.

In a primary embodiment method of removing indigo blue from a waste stream by adsorption onto a clay comprising the steps of: (i) mixing the waste stream suspected comprising the indigo blue with water in a tank to form a suspension, (ii) filtering the suspension through a mesh to remove suspended solids, (iii) adding the clay to the filtered suspension with mixing in a mixing tank; wherein the mixing in the mixing vessel is carried out for at least 24 hours, (iv) allowing the mixture of the clay and the filtered suspension to settle in the mixing tank to settle for at least two hours to form a clear supernatant solution and a solid residue and (v) separating the clear supernatant solution from the solid residue comprising the adsorbed indigo blue from the hydrous silicate mineral. In addition the method of the present invention further includes the steps of recycling the indigo blue free clear supernatant solution, drying the solid residue comprising the adsorbed indigo blue at a temperature not below 100° C. and for at least 24 hours, grinding the dried solid residue comprising the adsorbed indigo blue and adding pure fractions of indigo blue in varying amounts to the dried and ground solid residue to form a new pigment for further use.

In a specific aspect of the present invention the clay is Palygorskite. In other aspects the waste stream comprises of liquid effluents, solid effluents or both and the method of the present invention results in the removal of 30, 40, 50 or 60% of the salt and dye in the waste stream.

In a certain aspect of the present invention the pigment that is formed comprises Maya blue and wherein the pure fractions of the indigo blue that is added to form the pigment are at a weight % of 1%, 2%, 4%, 6%, and 8%.

In yet another aspect he clay is selected from [Si₈Mg₅O₂₀(OH)₂](H₂O)₄.4H₂O, derivatives or salts thereof. In further aspects the clear indigo blue free supernatant solution is recycled for use in a stonewash process, as irrigation water, as industrial grade water and for other processes and applications not requiring potable water.

Another embodiment of the present invention is directed towards a method of manufacturing a Maya blue pigment from indigo blue comprising the steps of: contacting an indigo blue solution with a solid support in a mixing vessel; wherein the mixing in the mixing vessel is carried out for at least 24 hours, allowing the mixture of the indigo blue solution and the solid support to settle in the mixing tank to settle for at least two hours to form a clear supernatant solution and a solid residue, separating the clear supernatant solution from the solid residue comprising the adsorbed indigo blue, drying the solid residue comprising the adsorbed indigo blue at a temperature not below 100° C. and for at least 24 hours, grinding the dried solid residue comprising the adsorbed indigo blue and adding pure fractions of indigo blue in varying amounts to the dried and ground solid residue to form the Maya blue pigment.

In one aspect the solid support is selected from one or more clays, soil, Palygorskite, mineral silicates, bentonite, or any combinations thereof. In another aspect the pure fractions of the indigo blue is added at a weight % of 1%, 2%, 4%, 6%, and 8%. In yet another aspect the solid support is selected from [Si₈Mg₅O₂₀(OH)₂](H₂O)₄.4H₂O, derivatives or salts thereof.

### BRIEF DESCRIPTION OF THE DRAWINGS

For a more complete understanding of the features and advantages of the present invention, reference is now made to the detailed description of the invention along with the accompanying figures and in which:

FIG. 1 is a process diagram showing the method of the present invention for the adsorption and recovery of waste indigo dye;

FIG. 2 shows the crystalline structure of palygorskite from (001) plane;

FIG. 3 shows the experimental and simulated X-ray diffractograms of palygorskite (λ=1.5418 A°);

FIG. 4 shows ESEM micrographs of indigo dye waste showing remnants of pumice rock;

FIG. 5 is the UV-Vis spectra of pigment samples (pure indigo and palygorskite);

FIG. 6 is the UV-Vis spectra of indigo waste with additional indigo dye (380-780 nm range shown);

FIG. 7 shows a graph depicting the relationship between indigo concentration and peak absorbance. (Waste: no additional indigo; other samples: waste with additional indigo as shown);

FIG. 8 shows the color variation with increasing concentration of indigo in (a) pure mixtures and (b) palygorskite-recovered waste. Each mixture heated at 170° C. for 24 h; and

FIG. 9 is the UV-Vis spectra of pigments prepared with salt-adsorbed clay (at 4% indigo).

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention is a simple and potentially cost-effective method of recovering indigo dye waste from the effluent through adsorption with palygorskite clay and subsequent conversion of recovery by-products into Maya blue, an organic-inorganic hybrid pigment with applications in the paint and coating industry. The present invention provides an attractive alternative to discharging the untreated effluent into municipal treatment plants or the environment through the production of a secondary commercial product from waste stream through a by-product synergy process.

Textile dyeing effluents present a substantial environmental problem, primarily because such effluents contain high concentrations of waste dyes, dye-products, and variable salts. The stonewashing process for the degradation of blue indigo to create a ‘faded’ look in blue denim results in high concentrations of indigo dye waste in the resulting effluent and because indigo is very difficult to decompose biologically, the effluent ends up in the environment, raising aesthetic concerns and damaging the integrity of the receiving streams. Wastewater containing indigo is characterized by a moderate amount of chemical oxygen demand (COD), pH, suspended solids, dissolved solids and a dark blue color. Although color and COD are some of the important parameters monitored to meet effluent discharge standards, companies are discouraged from treating or recovering the waste dye because of cost implications.

The stone-washing process to create a ‘faded’ look in blue denim discharges high amounts of indigo dye and uses large amounts of bleaching agents such as potassium permanganate and sodium hypochlorite, resulting in effluent characterized by large variability of chemical composition, high base content, and color.¹⁻³ These effluents often do not meet regulatory requirements for wastewater discharge even after undergoing treatment by conventional coagulation and activated sludge process because indigo is difficult to decompose biologically. The discharge of such dye wastewaters into the environment raises aesthetic concerns, impedes light penetration, damages the quality of receiving streams, and may be toxic to treatment processes, to food chain organisms, and to aquatic life in general. As regulations on effluent quality before discharge into municipal systems or streams become increasingly restrictive, the quality of the effluent could as well threaten permit renewal for these industries.⁴ It is therefore important to recover the dye before discharge, both from an ecological as well an economic standpoint.

Current pretreatment systems are large, expensive, and have little or no payback other than the elimination of sewer charges. Companies are therefore reluctant to adopt such measures simply out of concern for the environment, but they might do so to cut costs or to generate extra revenue. Some of the physical and chemical treatment techniques effective in color removal use more energy and chemicals and could potentially create even more toxic chemicals in the effluent through degradation or alteration of the conjugated system of dyes.⁵ Ultrafiltration (UF) and other membrane technologies can effectively remove indigo dye from the effluent but are prohibitively expensive. The wider application of these techniques is therefore hampered by toxicity or cost considerations.⁶ Indigo dye is extensively used by textile industries, specifically in the blue jeans industry⁷ and while about 80% of the indigo dye may be fixed onto the fabric, between 5 and 20% is removed and purged in the effluent stream. Typical dye house effluent concentrations for vat dyes such as indigo reported in literature range from 0.01 to 0.1 g l⁻¹.⁸⁻¹⁰ Since the eye can detect concentrations as low as 0.005 mg l⁻¹ of reactive dye in water, concentrations exceeding this level invariably raise concern on aesthetic ground By-product synergy, a concept supported and promoted by the US Business Council for Sustainable Development (USBCSD) and the World Business Council for Sustainable Development (WBCSD), refers to production of a secondary product in the course of a manufacturing process, resulting in substantial potential savings, efficient use of materials, and contributes towards meeting regulatory guidelines.¹¹ The development of a commercially feasible and economical method by which indigo may be recovered from the wastewater of denim yarn dye for reuse, therefore, promises to have substantial economic and environmental impact.

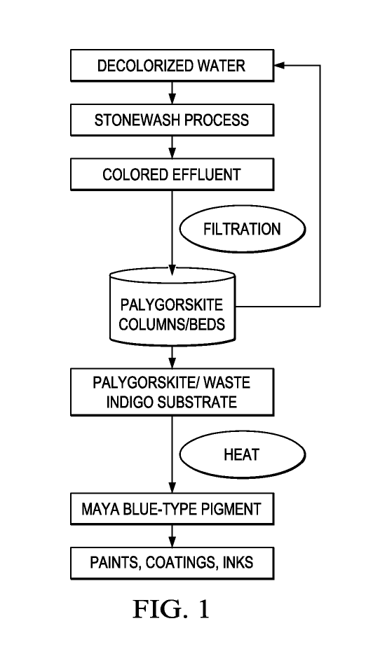

The present invention addresses this issue by the development of a potentially simple, cost effective process of waste indigo dye recovery using palygorskite (attapulgite) clay, and its incorporation in the production of a secondary product, Maya blue. A process diagram showing the method of the present invention for the adsorption and recovery of waste indigo dye and its conversion to the secondary product Maya blue is shown in FIG. 1.

Maya blue is a characteristic pigment of unparalleled stability used by the ancient Maya Indians in pottery and mural paintings. The characteristic blue-turquoise color is obtained only after heating a mixture of the clay palygorskite and organic dye indigo.¹²⁻¹³

Adsorption is the passive sequestration and separation of adsorbate from an aqueous phase onto a solid phase and depends mostly on the surface chemistry or nature of the adsorbent, adsorbate and the system conditions in between the two phases. Adsorption processes offer the most economical treatment of dye removal and can be carried out in a batch mode by adding the adsorbent to the waste, stirring the mixture for a sufficient time, allowing the adsorbent to settle, and drawing off the cleansed water.¹⁴ The adsorbate with the adsorbed waste dye is further processed into the by-product. The synthesis of Maya-type organic-inorganic complex pigments including Maya blue have been previously reported in literature.¹⁵ Unlike many other pigments, Maya blue does not contain heavy metals and is therefore environmentally friendly and has potential applications in the paint and coating industry.

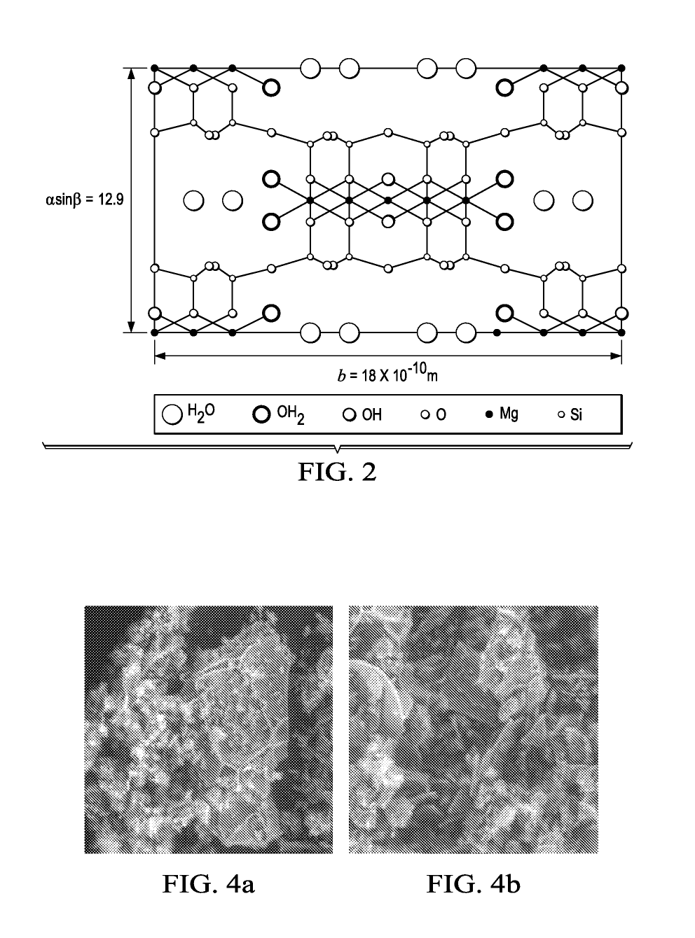

Palygorskite clay: Palygorskite is a hydrated magnesium silicate with partial isomorphic substitutions of magnesium and aluminium and/or iron. A two-layer clay consisting of tetrahedral SiO₄ and Al(OH)₃ with an octahedral Mg(OH)₂ layer between them, it has a fibrous texture with an internal structure of microchannels (measuring 3.7 A°×6.4 A° in cross section) and different bonded water molecules representing almost 20% of the structure's total weight. Palygorskite has the structural formula [Si₈O₂₀Mg₅(Al)(OH)₂](H2O)₄.4H₂O, and its crystalline structure as studied by Bradley¹⁶ is shown in FIG. 2. The clay has a fibrous texture with an internal structure of microchannels and different bonded water molecules that account for almost 20% of the structure's total weight. Besides surface water, palygorskite contains molecular or zeolitic water within the channels, water coordinated to the edge octahedral cations (also called “bound”, “crystalline” or “coordinated” water) and the normal hydroxyl group of 2:1 layer silicate at the center of the ribbon.¹⁷ Due to its structural morphology, considerable attention has been directed to its ability to adsorb organics on its surface.¹⁸

Indigo and Maya blue: Indigo (C₁₆H₁₀N₂O₂) is an organic colorant widely used for dyeing textiles and as a colorant for artistic pigments.¹⁹ Indigo molecules can enter the channels within the clay and form stable chemical bonds inside the clay. Heating the mixture causes the partial removal of zeolitic water^{20,21} or the elimination of structural water,²² emptying portions of the channels in which the indigo can be accommodated to form stable chemical bonds with the clay resulting in Maya blue, an organo-clay hybrid pigment with exceptional stability against chemical aggressors including acids, alkalis and chemical solvents. The pigment was originally invented and frequently used in murals, pottery and ceremonial artifacts by ancient Maya civilization in Mesoamerica during the 8th to 16th centuries.²³

Waste indigo dye—properties and extraction from solid waste: Solid indigo dye waste used to conduct studies in the present invention was obtained from the International Garment Processors (IGP) plant located outside the city limits of El Paso, Tex. IGP utilizes 100 mesh mechanical filters to separate by-products from the wastewater. These by-products, mainly indigo colored fibers, are removed from the denim garments during the abrading process and are stored in a landfill approximately 3120 cubic yards (2385 m³) in capacity—at a cost of $70,000 per year.

Approximately one million gallons of wastewater generated from the finishing process per day are then treated in large aerated lagoons. The treated water is utilized for irrigation of 50 acres of alfalfa. Salinity concentrations, however, exceed the established limits of sodium adsorption ratio (SAR) of 13.20. It was envisaged that palygorskite clay could address both problems simultaneously. The chemical characteristics of the wastewater from the IGP plant before aeration (influent) and after (effluent) are presented in Table 1. Aeration significantly reduces the biological oxygen demand (BOD), but it does not appreciably affect pH, total suspended solids (TSS), or the chemical oxygen demand (COD). While chemical oxygen demand is a measure of all chemicals in the water that can be oxidized, the BOD measures the amount of organic carbon that bacteria can oxidize. Indigo dye in the quinone form is highly insoluble in water and extremely recalcitrant to biological degradation, which largely explains the high level of the nondestructible COD in the effluent-irrigation tank. The level of total suspended solids, which includes the indigo waste dye, remains virtually unchanged both at the influent and effluent end.

TABLE 1
Chemical composition of influent-aeration and effluent irrigation tanks.

| | Influent- | Effluent- | |
|---|---|---|---|
| Parameter | aeration tank | irrigation tank | Method |
| pH | 7.5 | 7.4 | EPA 150.1 |
| BOD/mg l⁻¹ | 95 | 44 | EPA 405.1 |
| TSS/mg l⁻¹ | 2418 | 2548 | EPA 160.1 |
| COD/mg l⁻¹ | 131 | 125 | EPA 160.1 |

Simulated effluent: Indigo dye waste was reconstituted from solid waste. Solid waste was dissolved in distilled water (1:50 w/v) and the suspension passed through a 100 mesh screen to remove suspended solids. 1 g of palygorskite clay was added to 100 ml of the waste solution and stirred on an orbital shaker at 400 rpm for 24 h. The suspension was then allowed to settle for 2 h resulting in a clear solution. The clear supernatant was decanted and the remaining solids dried for 24 h at 100° C. and then ground in a mortar. The elemental composition of the solid indigo waste obtained from the International Garment Processors plant at El Paso is shown in Table 3 (vide infra)

TABLE 2
Elemental composition of palygorskite clay.

| Element | Wt % | Atom % |
|---|---|---|
| C | 3.86 | 6.17 |
| O | 55.56 | 66.64 |
| Na | 0.58 | 0.49 |
| Mg | 6.38 | 5.03 |
| Al | 4.25 | 3.02 |
| Si | 24.45 | 16.71 |
| K | 0.87 | 0.42 |
| Ca | 0.94 | 0.45 |
| Fe | 3.12 | 1.07 |
| Total | 100 | 100 |

TABLE 3
Elemental composition of solid indigo
dye waste from IGP plant, El Paso, TX.

| Element | Wt % | Atom % | K-Ratio | Z | A | F |
|---|---|---|---|---|---|---|
| C | 15.51 | 24.21 | 0.0258 | 1.0388 | 0.1598 | 1.0004 |
| O | 43.69 | 51.18 | 0.0853 | 1.0214 | 0.1911 | 1.0003 |
| Na | 0.03 | 0.02 | 0.0001 | 0.956 | 0.2462 | 1.0027 |
| Mg | 2.14 | 1.65 | 0.0076 | 0.98 | 0.3585 | 1.0049 |
| Al | 3.95 | 2.74 | 0.0179 | 0.9513 | 0.4738 | 1.0077 |
| Si | 20.93 | 13.97 | 0.1161 | 0.979 | 0.5655 | 1.0015 |
| P | 0.59 | 0.36 | 0.0026 | 0.9426 | 0.4584 | 1.0021 |
| S | 0.53 | 0.31 | 0.0029 | 0.9629 | 0.5726 | 1.0032 |
| a | 0.54 | 0.29 | 0.0034 | 0.921 | 0.6786 | 1.005 |
| K | 4.02 | 1.93 | 0.0317 | 0.928 | 0.8441 | 1.007 |
| Ca | 4.89 | 2.29 | 0.0402 | 0.95 | 0.8644 | 1.0012 |
| Fe | 3.17 | 1.06 | 0.0273 | 0.8628 | 0.9968 | 1.000 |
| Total | 100 | 100 | | | | |

^{a} K-Ratio = X-ray intensity; Z = correction factor, A = absorption; F = fluorescence.

Clay mineral and pigment characterization: Palygorskite clay (Mintech 325A, Mintech International, Inc.) was characterized to determine its mineralogical composition (XRD), its surface topography and microanalysis by an environmental scanning electron microscope (ESEM) equipped with an EDAX system. Pigment samples were prepared by mixing, grinding, and then heating the mixtures to 170° C. for 24 h. in Indigo content ranged from 1% to 8%. The resulting pigment samples were analyzed by UV-Vis.

X-Ray diffraction (XRD): Wide-angle X-ray spectra were recorded with a Scintag model XDS2000 (Scintag, Inc.) diffractometer fitted with a copper anode X-ray source generating a wavelength of 1.5406 A°. The X-ray source was operated at 40 mA and 45 kV in step mode with a scan rate of 0.041 min⁻¹ and step width of 0.021. The typical angle diffractometer range was set from 5 to 801. For the purposes of the present invention, a range of 5 to 401 is shown as no useful information was obtained outside this range.

Microscopic examination (ESEM): The morphology of the samples was inspected in an environmental scanning electron microscope (ESEM). One advantage of ESEM over conventional scanning electron microscopy (SEM) is that it ESEM allows the imaging of systems with no prior specimen preparation and does not require that materials be coated by gold-palladium, thus preserving the original characteristics of the sample. An FEI-Electroscan ESEM 2020 (Hillsboro, Oreg.) with a cerium hexaboride electron source, long working distance gaseous secondary electron detector, and an EDAX DX Prime EDS detector (Mahwah, N.J.) was used to characterize the clay for compositional analysis. The accelerating voltage was 20 kV, beam current was roughly 0.2 nA, and water vapor was used as the chamber gas. Samples were fixed to the aluminum sample stub with double-sided conductive copper tape. Images were collected using a 30 s integration period. Pigment samples were prepared by grinding the appropriate ratios of clay and indigo dye in a mortar and heating the mixtures at 170° C. for 24 h. A similar set of samples was prepared using palygorskite-indigo waste as the substrate. Indigo dye in the pigments ranged from 1% to 8% by weight. Reflectance spectra were measured by a PC model 3101 spectrophotometer (Shimadzu) using BaSO₄ as a background.

Salt adsorption and effect on pigment properties: Wastewater effluent contains both organic and inorganic constituents both of which are adsorbed onto the palygorskite.

A range of sodium chloride solutions with a concentration range of 250-2000 ppm was used as a proxy to study the salt adsorption dynamics of palygorskite, and the effect of the interaction between inorganic contaminants and palygorskite on pigment properties. A stock solution of sodium chloride was prepared by dissolving 2 g of AnalaR grade sodium chloride salt crystals in 1 l of distilled water for a final concentration of 2000 mg l⁻¹.

Standard solutions of 250, 500, 1000 and 2000 ppm were prepared by transferring the respective aliquots of the stock solution to a 100 ml volumetric flask and bringing the final volume to 100 ml. Next, 1 g of palygorskite was added to each of the solutions and the suspension stirred for 24 h. The suspensions were then vacuum-filtered using a glass microfiber filter (Whatman 934-AH, 110 mm diameter). The concentration of sodium in the filtrate was the analyzed by inductively coupled plasma (ICP) (EPA Method 4.1.3/200.7). The filtered clay was dried at 100° C. for 24 h and elemental analysis done. UV-Vis analysis was run on pigments prepared from the extract palygorskite at 4% indigo.

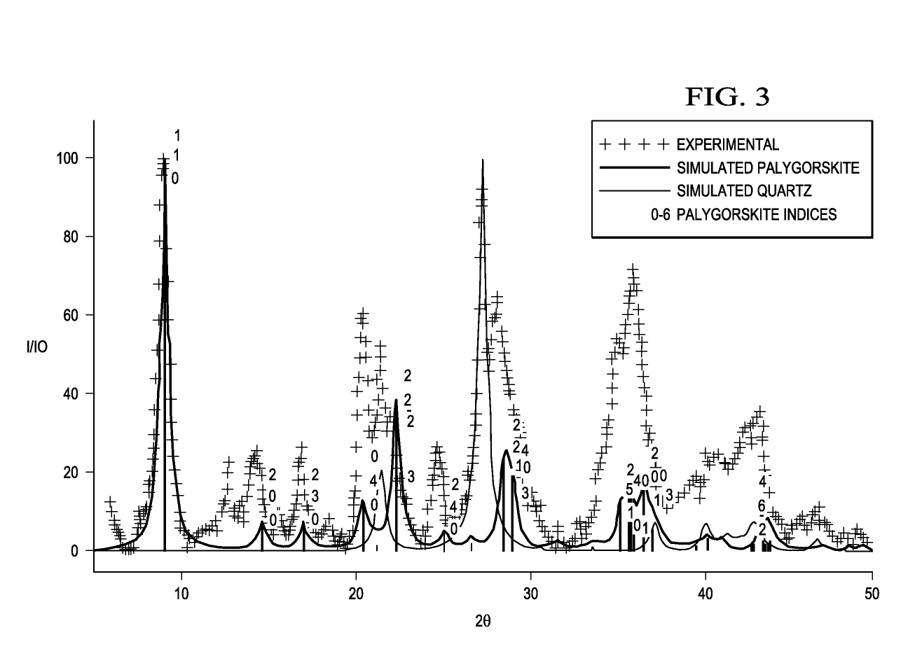

FIG. 3 shows the experimental and simulated X-ray pattern of the clay used in the present invention. The simulated X-ray pattern is based on an idealized crystal structure of palygorskite. The data confirmed the clay to be predominantly palygorskite, with traces of silica/quartz. Peaks obtained are typical for palygorskite with peaks at 2y=8.3, 13.6, 19.7, and 26.61 corresponding to the primary diffraction of the (110), (200), (040), and (400) planes of the clay, respectively as reported previously in literature^{24,25} and confirmed by simulation with Cerius2 Molecular Modeling (Accelrys2).

The scanning electro microscope permits the observation of materials in macro and submicron ranges and is capable of generating three-dimensional images for analysis of topographic features. When used in conjunction with EDS (EDX, EDAX), the elemental analysis on microscopic sections of the material or contaminants that may be present is revealed. The elemental composition of the palygorskite clay is shown in Table 2. The elemental analysis of the indigo dye waste (Table 3) shares some elemental constituents with that of palygorskite, presumably from the pumice rocks used in the stonewash process.

Environmental scanning electron microscopy (ESEM) combined with energy dispersive X-ray analysis (EDX) of the indigo dye waste confirms a clay with organic colloids/tissue properties as evidenced by the presence of phosphorus, sulfur, and chlorine (FIG. 4 and Table 3).

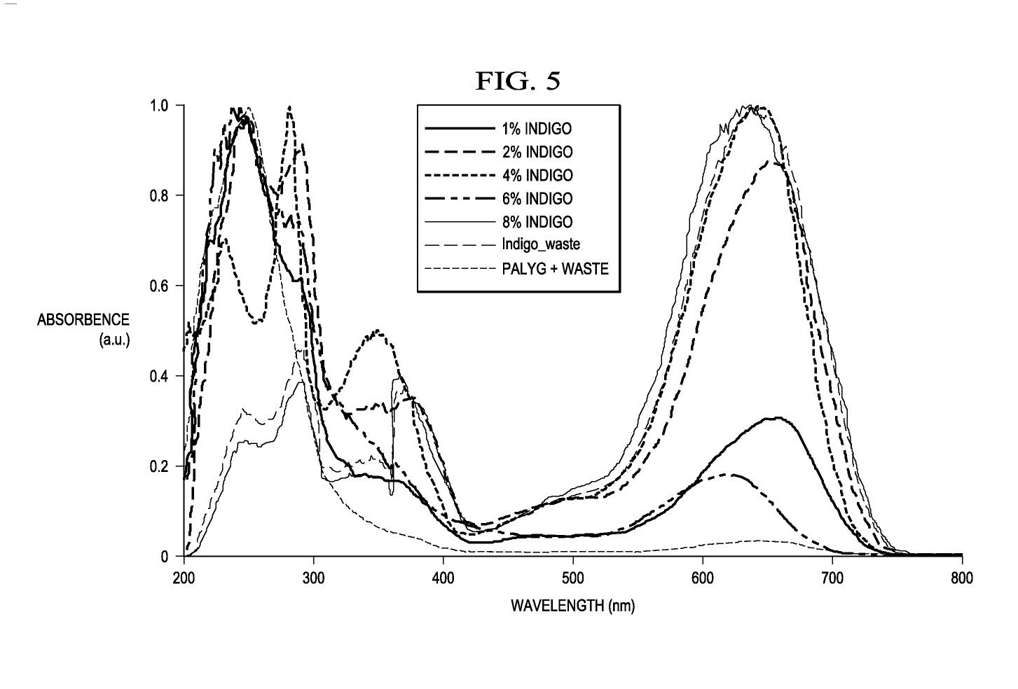

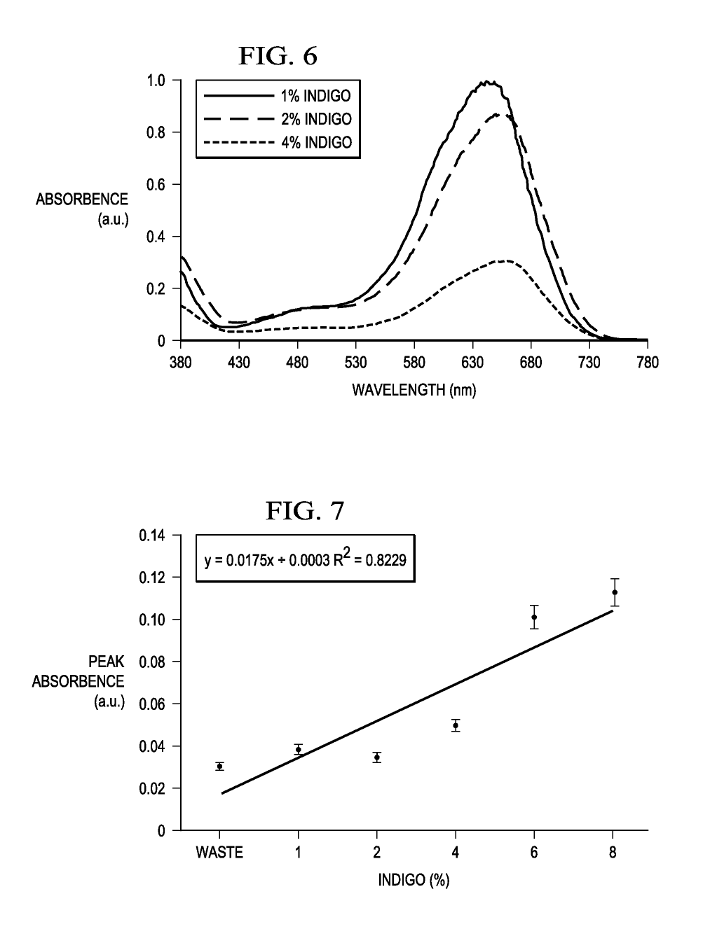

UV-Vis spectrophotometry was used to determine and compare the absorbance of pigment samples prepared from pure indigo and palygorskite. Indigo waste was included for comparative purposes. For all pigment samples, peak absorbance occurs around 620-650 nm. Absorbance increases with the concentration of indigo in the pigment (FIG. 5). The UV-Vis spectra of pigment samples derived from indigo waste fortified with additional indigo dye are shown in FIG. 6. Peak absorbance of the resulting pigments shifts to the left with increasing indigo dye concentration. The data also confirm the concentration of indigo dye in the waste to be well below 1%, in line with results reported in the literature. A plot of the relative peak absorbance for pigments ranging from 1% to 8% indigo content shows an approximately linear relationship with increasing indigo content (FIG. 7). Waste indigo, which contains low levels of recoverable indigo dye from the textile effluent, was included in the study for comparative purposes.

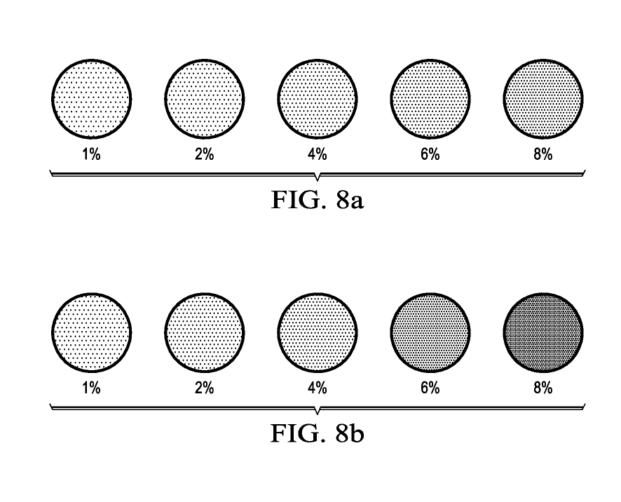

Color variation: pure mixtures versus samples from waste Pigment samples were prepared using palygorskite and indigo in incremental amounts or indigo waste as the substrate with additional indigo dye amounts added incrementally. The pigment samples were prepared by grinding and mixing the appropriate fractions of palygorskite-indigo and/or indigo waste-indigo mixtures, which were then placed in an oven at 170° C. for 24 h. The pigments were then scanned for color for comparison (FIG. 8). As expected, the color became darker with increasing indigo concentration for both sample lots. There is however, a perceptible color difference between them depending on the substrate. Pigments made using the indigo waste as the substrate have discernible vibrancy in color relative to those synthesized from pure palygorskite and indigo, which could probably be ascribed to the presence of organic constituents (P, S, and Cl) found only in the solid dye waste and not in any of the pure components.

Adsorption characteristics of palygorskite: The use of large amounts of bleaching agents such as potassium permanganate and sodium hypochlorite results in effluent with a large variability of chemical composition and a high base content. Palygorskite clay shows significant potential for removing salts from solution (Table 4).

TABLE 4
Sodium adsorption by palygorskite in aqueous solution.

| Initial Na⁺ | Final Na⁺ | |
|---|---|---|
| concentration (ppm) | concentration (ppm) | % Removal |
| 250 | 120 | 52 |
| 500 | 221 | 55.8 |
| 1000 | 365 | 63.5 |
| 2000 | 796 | 60.2 |

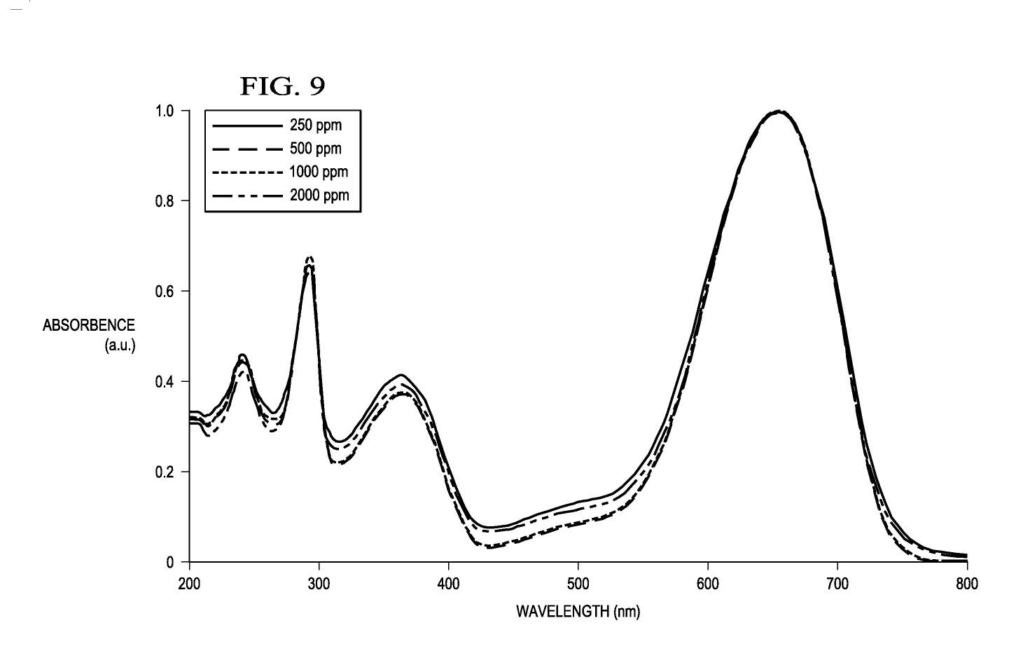

The clay used in the adsorption of salts was dried at 100° C. for 24 h and used in the preparation of pigments. Pigment samples were prepared by grinding the clay and indigo and subjecting the ground mixture to 170° C. for 24 h before UV-Vis analysis (FIG. 9). All pigment samples contained 4% indigo by composition. The spectral response for all pigments was uniform over the range of salt concentration tested. It is significant that the level of salt concentration does not seem to adversely affect the color properties of the resulting pigments.

The adsorption of waste indigo dye and associated salts from textile wastewater onto palygorskite clay and its conversion to a commercial by-product, Maya blue, is described in the presen invention Palygorskite clay effectively adsorbs the indigo dye from textile wastewater, significantly reducing color. The recovered by-product was used as the precursor for the synthesis of Maya blue pigment. The recovery of the indigo dye waste as described herein, offers the potential for recycling or reuse of the waste indigo dye in textile effluent. The adsorbents, described in the present invention are mainly clays, are readily available, are inexpensive, and offer a cost-effective alternative to conventional treatment of waste streams. Given the price of the palygorskite clay relative to activated carbon and polymer resins, adsorption by palygorskite appears to be a cost-effective method for the treatment of aqueous effluents both from the standpoint of color removal and revenue generation. Pigments synthesized from the recovery process and fortified with additional indigo dye produced results that compared favorably with pigments synthesized from pure components.

Salt removal levels of over between 52% and 63.5% were achieved across a test range of 250 to 2000 ppm of salt concentration, using sodium chloride as a proxy. Sodium (Na⁺) is probably the most common constituent of textile wastewaters due to the wide range of sodium salts used at various stages of the textile wet process. The presence of salt in palygorskite used in the recovery process does not seem to adversely affect the color properties. On the contrary the salt appears to improve the color, and therefore the quality of pigments synthesized with the clay used in the adsorption. The use of palygorskite clay in the recovery of waste indigo dye and salts from textile effluent and the synthesis of a potential commercial by-product implies significant economic as well as ecological implications.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Pat. No. 4,045,171: Treatment of dye wastes.
U.S. Pat. No. 5,980,981: Process for desizing and cleaning woven fabrics and garments.
CN101314487: Method for removing cation type dye in printing and dyeing wastewater.
¹ R. Campos, A. Kandelbauer, K. H. Robra, A. Cavaco-Paulo and G. M. Gubitz, J. Biotechnol., 2001, 89, 131.
² M. Kobya, T. C. Orhan and M. Bayramoglu, J. Hazard. Mater., 2003, B100, 163.
³ S. P. Kim, P. Chulhwan, K. Tak-Hyun, L. Jjnwon and K. Seung, J. Biol. Bioeng., 2003, 95, 202.
⁴ O. Marmagne and C. Coste, Am. Dyest. Rep., April 1996, 15.
⁵ D. L. Woerner, Membrane technology in textile operations, Koch Membrane Systems, Wilmington, Mass., undated.
⁶ Y. Yang, D. T. Wyatt and M. Barhoshky, Text. Chem. Color., 1998, 30, 27.
⁷ B. Manu and S. Chaudhari, Process Biochem., 2003, 38, 1213.
⁸ I. G. Laing, Rev. Prog. Color. Relat. Top., 1991, 21, 56.
⁹ J. Jia, J. Yang, W. Wang and Z. Wang, Water Res., 1999, 33, 881.
¹⁰ X. Z. Li and M. Zang, Water Sci. Technol., 1996, 34, 49.
¹¹ US Business Council for Sustainable Development. http://www.usbcsd.org.
¹² R. J. Gettens, Am. Antiq., 1962, 7(4), 557.
¹³H. Van Olphen, Science, 1966, 154, 645.
¹⁴ R. Sanghi and B. Bhattacharya, Color. Technol., 2002, 118, 256.
¹⁵ L. A. Polette-Niewold, F. S. Manciu, B. Tones, M. Alvarado, Jr and R. R. Chianelli, J. Inorg. Biochem., 2007, 101, 1958.
¹⁶ W. F. Bradley, Am. Mineral., 1940, 25, 405.
¹⁷ The interaction of water with clay mineral surfaces, ed. A. C. D. Newman, Chemistry of Clays and Clay Mineral, Mineralogical Society Monograph, Longman Scientific and Technical, London, England, 1987, vol. 6.
¹⁸H. Shariatmadari, A. R. Mermut and M. B. Benke, Clays Clay Miner., 1999, 47(1), 44.
¹⁹ L. Wang and J. Sheng, Polymer, 2005, 46, 6243.
²⁰ M. Sanchez Del Rio, P. Martinetto, C. Reyes-Valerio, E. Dooryhee and M. Suarez, Archaeometry, 2006, 48(1), 115.
²¹ R. Kleber, R. Masschelein-Kleiner and J. Thissen, Stud. Conserv., 1967, 12(2), 41.
²² G. Chiari, R. Giustetto and G. Ricchiardi, Eur. J. Mineral., 2003, 15(1), 21.
²³ D. Reinen, P. Kohl and C. Muller, Z. Anorg. Allg. Chem., 2004, 630, 97.
²⁴ E. Fois, A. Gamba and A. Tilocca, Microporous Mesoporous Mater., 2003, 57(3), 263.
²⁵ J. A. C. Ruiz, D. M. A. Melo, J. R. Souza and L. O. Alcazar, Materials Research, 2002, 5(2), 173.

What is claimed is:

1. A method of removing a suspected dye contaminant from a waste stream by adsorption onto a crystalloid hydrous silicate mineral comprising the steps of:
mixing the waste stream comprising the suspected dye contaminant with water in a tank to form a suspension;
filtering the suspension through a mesh to remove suspended solids;
mixing the crystalloid hydrous silicate mineral and the filtered suspension in a mixing tank for at least 24 hours;
allowing the mixture of the crystalloid hydrous silicate mineral and the filtered suspension to settle in the mixing tank for at least two hours to form a clear supernatant solution and a solid residue; and
separating the clear supernatant solution from the solid residue comprising the suspected dye contaminant; wherein the suspected dye contaminant is adsorbed on the hydrous silicate mineral.

2. The method of claim 1, further comprising the steps of:
recycling the clear supernatant solution;
drying the solid residue comprising the adsorbed suspected dye contaminant;
grinding the dried solid residue comprising the adsorbed suspected dye contaminant; and
adding fractions of a pure dye in varying amounts to the dried solid residue to form a new pigment.

3. The method of claim 1, wherein the hydrous silicate mineral is selected from one or more clays, soil, palygorskite, mineral silicates, bentonite, or any combinations thereof.

4. The method of claim 1, wherein the waste stream comprises of liquid effluents, solid effluents or both.

5. The method of claim 1, wherein the suspected dye contaminant comprises indigo blue, acid dyes, basic dyes, mordant dyes, vat dyes, azo dyes, or any combinations thereof.

6. The method of claim 1, wherein the method removes 30%, 40%, 50% or 60% of the salt and the suspected dye contaminant in the waste stream.

7. The method of claim 1, wherein the hydrous silicate mineral is selected from [Si₈Mg₅O₂₀(OH)₂](H₂O)₄.4H₂O, derivatives or salts thereof.

8. The method of claim 2, wherein the new pigment comprises Maya blue, metallic pigments, carbon pigments, organic pigments, biological pigments, or any combinations thereof.

9. The method of claim 2, wherein the pure dye is added at a weight percentage of 1%, 2%, 4%, 6%, and 8%.

10. The method of claim 2, wherein the solid residue comprising the adsorbed suspected dye contaminant is dried at a temperature of at least 100° C. and for at least 24 hours.

11. The method of claim 2, wherein the clear supernatant solution is recycled for use in a stonewash process, as irrigation water, as industrial grade water and for other processes not requiring potable water.

12. A method of removing an indigo blue contaminant from a waste stream by adsorption onto a clay comprising the steps of:
mixing the waste stream comprising the indigo blue contaminant with water in a tank to form a suspension;
filtering the suspension through a mesh to remove suspended solids;
adding the clay to the filtered suspension with mixing in a mixing vessel; wherein the mixing in the mixing vessel is carried out for at least 24 hours;
allowing the mixture of the clay and the filtered suspension to settle in the mixing vessel to settle for at least two hours to form a clear supernatant solution and a solid residue; and
separating the clear supernatant solution from the solid residue; wherein the solid residue comprises the indigo blue contaminant adsorbed on the hydrous silicate mineral.

13. The method of claim 12, further comprising the steps of:
recycling the indigo blue free clear supernatant solution;
drying the solid residue comprising the adsorbed indigo blue;
grinding the dried solid residue comprising the adsorbed indigo blue; and
adding fractions of a pure indigo blue solution in varying amounts to the dried and ground solid residue to form a new pigment.

14. The method of claim 12, wherein the clay is palygorskite.

15. The method of claim 12, wherein the clay is selected from [Si₈Mg₅O₂₀(OH)₂](H₂O)₄.4H₂O, derivatives or salts thereof.

16. The method of claim 12, wherein the waste stream comprises of liquid effluents, solid effluents or both.

17. The method of claim 12, wherein the method removes 30%, 40%, 50% or 60% of the salt and the indigo blue in the waste stream.

18. The method of claim 13, wherein the solid residue comprising the adsorbed indigo blue is dried at a temperature of at least 100° C. and for at least 24 hours.

19. The method of claim 13, wherein the new pigment comprises Maya blue.

20. The method of claim 13, wherein the fractions of the pure indigo blue solution are added at a weight percent of 1%, 2%, 4%, 6%, and 8%.

21. The method of claim 13, wherein the indigo blue free clear supernatant solution is recycled for use in a stonewash process, as irrigation water, as industrial grade water and for other processes and applications not requiring potable water.

22. A method of manufacturing a Maya blue pigment from an indigo blue solution comprising the steps of:
adding the indigo blue solution to a solid support in a mixing vessel to form a mixture; wherein the mixing in the mixing vessel is carried out for at least 24 hours
allowing the mixture of the indigo blue solution and the solid support to settle in the mixing vessel to settle for at least two hours to form a clear supernatant solution and a solid residue;
separating the clear supernatant solution from the solid residue comprising the adsorbed indigo blue;
drying the solid residue comprising the adsorbed indigo blue;
grinding the dried solid residue comprising the adsorbed indigo blue; and
adding fractions of a pure indigo blue solution in varying amounts to the dried solid residue to form the Maya blue pigment.

23. The method of claim 22, wherein the solid support is selected from at least one of clays, soil, palygorskite, mineral silicates, bentonite, or any combination thereof.

24. The method of claim 22, wherein the fractions of the pure indigo blue solution are added at a weight percent of 1%, 2%, 4%, 6%, and 8%.

25. The method of claim 22, wherein the solid support is selected from [Si₈Mg₅O₂₀(OH)₂](H₂O)₄.4H₂O, derivatives or salts thereof.

26. The method of claim 22, wherein the solid residue comprising the adsorbed indigo blue is dried at a temperature of at least 100° C. and for at least 24 hours.
